(19) United States
(12) Patent Application Publication
(10) Pub. No.: US 2025/0201827 A1
(43) Pub. Date: Jun. 19, 2025

(54) BATTERY

(71) Applicants: TOYOTA JIDOSHA KABUSHIKI KAISHA, Aichi-ken (JP); OSAKA UNIVERSITY, Osaka (JP)

(72) Inventors: Kyosuke YOSHIDA, Susono-shi (JP); Yuki YAMADA, Osaka (JP); Kouki OKA, Osaka (JP); Yasuyuki KONDO, Osaka (JP); Shoma NISHIMURA, Osaka (JP)

(21) Appl. No.: 18/931,044

(22) Filed: Oct. 30, 2024

(30) Foreign Application Priority Data
Dec. 15, 2023 (JP) 2023-211879

(51) Int. Cl. H01M 4/38; H01M 4/02; H01M 10/0567; H01M 10/0568

(52) U.S. Cl. CPC H01M 4/386; H01M 10/0567; H01M 10/0568; H01M 2004/021; H01M 2004/027

(57) ABSTRACT

The disclosure relates to a battery having a positive electrode layer, an electrolyte layer and a negative electrode layer in that order, wherein the electrolyte layer contains dimethylsulfamoyl fluoride (MeFSA) and lithium bis(fluorosulfonyl)imide (LiFSI), and the negative electrode layer contains a Si-based active material as a negative electrode active material.

### CROSS-REFERENCE TO RELATED APPLICATION

This application claims priority to Japanese Patent Application No. 2023-211879 filed on Dec. 15, 2023, incorporated herein by reference in its entirety.

### BACKGROUND

### 1. Technical Field

The present disclosure relates to a battery.

### 2. Description of Related Art

Various techniques have been proposed for batteries containing a Si-based active material as a negative electrode active material as disclosed in Japanese Unexamined Patent Application Publication No. 2023-044620 (JP 2023-044620 A).

### SUMMARY

When a Si-based active material is used as a negative electrode active material in a liquid battery, there is room for improvement in terms of reducing the irreversible capacity.

The present disclosure has been made in view of the above circumstances, and a main object of the present disclosure is to provide a battery that can reduce an irreversible capacity.

Specifically, the present disclosure includes the following aspects.

<1> A battery having a positive electrode layer, an electrolyte layer and a negative electrode layer in that order,
wherein the electrolyte layer contains dimethylsulfamoyl fluoride (MeFSA) and lithium bis(fluorosulfonyl)imide (LiFSI), and
wherein the negative electrode layer contains a Si-based active material as a negative electrode active material.

<2> The battery according to <1>,
wherein the molar ratio of LiFSI and MeFSA is LiFSI:MeFSA=1:12 to 1:3.

<3> The battery according to <1> or <2>,
wherein the negative electrode active material is a porous Si clathrate.

<4> The battery according to any one of <1> to <3>,
wherein the negative electrode active material is a negative electrode active material particle, and
wherein the D50 of the negative electrode active material particle is 0.7 μm or less.

<5> The battery according to any one of <1> to <4>,
wherein the negative electrode active material is a negative electrode active material particle, and
wherein the specific surface area of the negative electrode active material particle is 25 to 60 m²/g.

The battery of the present disclosure can reduce the irreversible capacity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating the difference in Li metal negative electrode potential between the case of a conventional electrolytic solution and the case of an electrolytic solution using dimethylsulfamoyl fluoride (MeFSA) as a solvent of the present disclosure; and

FIG. 2 is a graph showing the initial coulombic efficiency, average coulombic efficiency, and discharging capacity retention rate measured in Examples 7 to 9, and 13 to 15 and Comparative Examples 1 to 6.

### DETAILED DESCRIPTION OF EMBODIMENTS

Embodiments of the present disclosure will be described below. Here, components other than those particularly mentioned in this specification that are necessary for implementation of the present disclosure (for example, a general configuration and a production process of a battery that do not characterize the present disclosure) can be recognized by those skilled in the art as design matters based on the related art in the field. The present disclosure can be implemented based on content disclosed in this specification and common general technical knowledge in the field.

In the present disclosure, unless otherwise specified, the average particle size (D50) of particles is a particle diameter (median diameter) value at a cumulative value of 50% in the volume-based particle size distribution measured by laser diffraction/scattering type particle size distribution measurement.

In the present disclosure, there is provided a battery having a positive electrode layer, an electrolyte layer and a negative electrode layer in that order, wherein the electrolyte layer contains dimethylsulfamoyl fluoride (MeFSA) and lithium bis(fluorosulfonyl)imide (LiFSI), and the negative electrode layer contains a Si-based active material as a negative electrode active material.

The solid electrolyte interphase (SEI), which is a coating formed mainly by reductive decomposition of an electrolytic solution during charging at the interface between the negative electrode and the electrolytic solution of the battery, partially collapses due to volume change during charging and discharging of the Si-based active material, and during recharging after collapse, a thick and uneven SEI with an irregular shape is surface-formed. Accordingly, the function of the SEI as an interface protection layer deteriorates and the reductive decomposition of the electrolytic solution proceeds. Since the SEI continues to grow due to repeated charging and discharging, the resistance of the battery increases according to charging and discharging, the coulombic efficiency of the battery decreases, and the capacity retention rate decreases.

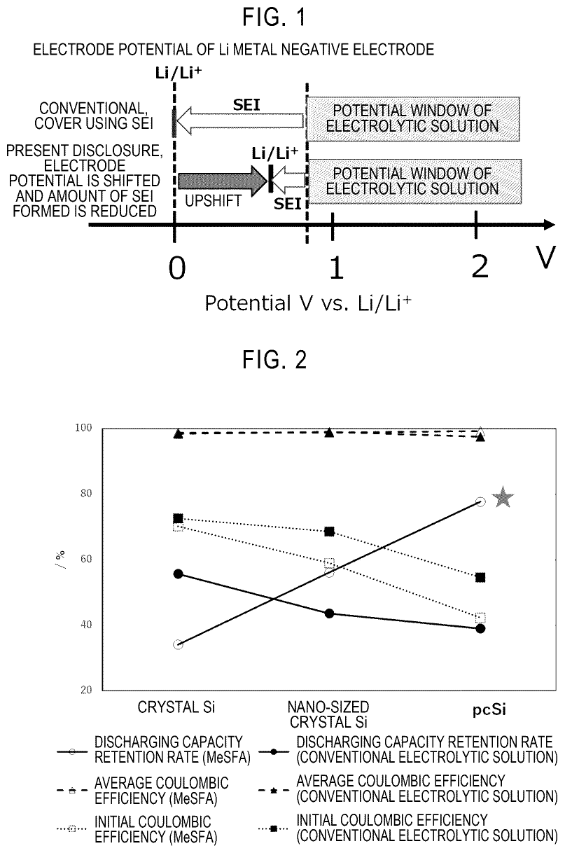

FIG. 1 is a diagram illustrating the difference in Li metal negative electrode potential between the case of a conventional electrolytic solution and the case of an electrolytic solution using dimethylsulfamoyl fluoride (MeFSA) as a solvent of the present disclosure.

As shown in FIG. 1, conventionally, the SEI filled the gap between the potential window of the electrolytic solution and the Li metal negative electrode potential, but in the present disclosure, when the Li metal negative electrode potential is brought closer to the reduction-side potential window of the electrolytic solution (upshifting), the electrode reaction becomes more likely to proceed even without the formation of an SEI, the reductive decomposition of the thermodynamically electrolytic solution is restricted and the state of the electrolytic solution is stabilized. The same effect can be obtained by changing the Li metal negative electrode to a high-capacity negative electrode (a negative electrode containing a Si-based active material).

The battery of the present disclosure has a positive electrode, an electrolyte layer and a negative electrode in that order.

### Positive Electrode

The positive electrode has a positive electrode layer. The positive electrode includes, as necessary, a positive electrode current collector.

### Positive Electrode Layer

The positive electrode layer contains a positive electrode active material, and may contain, as optional components, a solid electrolyte, a conductive material, a binder and the like.

Examples of positive electrode active materials include lithium, lithium nickel cobalt aluminum oxide (NCA), LiCoO₂, LiNiₓCo₁₋ₓO₂ (0<x<1), Li(Ni_{0.8}Co_{0.1}Mn_{0.1})O₂ (NCM811), LiNi_{1/3}Co_{1/3}Mn_{1/3}O₂, LiMnO₂, LiMn₂O₄, LiNiO₂, LiVO₂, Li—Mn spinels substituted with different elements, lithium titanate, lithium metal phosphate, LiCON, Li₂SiO₃, and Li₄SiO₄. Examples of Li—Mn spinels substituted with different elements include LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄. Examples of lithium titanates include Li₄Ti₅O₁₂. Examples of lithium metal phosphates include LiFePO₄, LiMnPO₄, LiCoPO₄, and LiNiPO₄.

The shape of the positive electrode active material is not particularly limited, and may be a particle shape (positive electrode active material particle).

A coating layer containing a Li-ion conducting oxide may be formed on the surface of the positive electrode active material. This is because the reaction between the positive electrode active material and the solid electrolyte can be restricted.

Examples of Li-ion conducting oxides include LiNbO₃, Li₄Ti₅O₁₂, and Li₃PO₄. The thickness of the coating layer is, for example, 0.1 nm or more, and may be 1 nm or more. On the other hand, the thickness of the coating layer is, for example, 100 nm or less, and may be 20 nm or less. The coverage of the coating layer on the surface of the positive electrode active material is, for example, 70% or more, and may be 90% or more.

Examples of solid electrolytes include oxide-based solid electrolytes and sulfide-based solid electrolytes.

Examples of sulfide-based solid electrolytes include solid electrolytes containing elemental Li, elements M (M is at least one of P, As, Sb, Si, Ge, Sn, B, Al, Ga, and In), and elemental S. In addition, the sulfide-based solid electrolyte may further contain at least one of elemental O and a halogen element.

Examples of sulfide-based solid electrolytes include Li₂S—P₂S₅, Li₂S—SiS₂, LiX—Li₂S—SiS₂, LiX—Li₂S—P₂S₅, LiX—Li₂O—Li₂S—P₂S₅, LiX—Li₂S—P₂O₅, LiX—Li₃PO₄—P₂S₅, and Li₃PS₄. Here, the above reference to “Li₂S—P₂S₅” means a material obtained using a raw material composition containing Li₂S and P₂S₅, and the same applies to other description.

In addition, “X” in the LiX indicates a halogen element. Examples of halogen elements include elemental F, elemental Cl, elemental Br, and elemental I. The LiX-containing raw material composition may contain one, two or more types of LiX. When two or more types of LiX are contained, the mixing ratio of two or more types is not particularly limited.

The molar ratio of the elements in the sulfide-based solid electrolyte can be controlled by adjusting the content of each element in the raw material. In addition, the molar ratio and compositions of the elements in the sulfide-based solid electrolyte can be measured through, for example, ICP emission spectroscopy.

The sulfide-based solid electrolyte may be sulfide glass or crystallized sulfide glass (glass ceramics) or may be a crystalline material obtained by performing a solid-phase reaction treatment on the raw material composition.

The crystalline state of the sulfide-based solid electrolyte can be confirmed, for example, by performing powder X-ray diffraction measurement using CuKα rays for the sulfide-based solid electrolyte.

Sulfide glass can be obtained by performing amorphous processing on the raw material composition (for example, a mixture of Li₂S and P₂S₅). Examples of amorphous processing include mechanical milling.

Glass ceramics can be obtained by heating, for example, sulfide glass.

The heat treatment temperature may be a temperature higher than the crystallization temperature (Tc) of sulfide glass observed by thermal analysis measurement, and is generally 195° C. or higher. On the other hand, the upper limit of the heat treatment temperature is not particularly limited.

The crystallization temperature (Tc) of sulfide glass can be measured by differential thermal analysis (DTA).

The heat treatment time is not particularly limited as long as it is a time during which a desired degree of crystallization of glass ceramics is obtained, and is, for example, in a range of 1 minute to 24 hours, and particularly in a range of 1 minute to 10 hours.

The heat treatment method is not particularly limited, and for example, a method using a baking furnace can be used.

Examples of oxide-based solid electrolytes include substances having a garnet-type crystal structure containing elemental Li, elemental La, elements A (A is at least one of Zr, Nb, Ta, and Al), and elemental O. Examples of oxide-based solid electrolytes include Li₂O—B₂O₃—P₂O₅, Li₂O—SiO₂, Li₂O—B₂O₃, Li_{1.3}Al_{0.3} Ti_{0.7} (PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄, and Li₃₊ₓPO₄₋ₓNₓ (1≤x≤3).

The shape of the solid electrolyte may be a particle shape in consideration of ease of handling.

In addition, the average particle size (D50) of the solid electrolyte particle is not particularly limited, and the lower limit may be 0.5 μm or more, and the upper limit may be 2 μm or less.

The content of the solid electrolyte in the positive electrode layer is not particularly limited, and may be, for example, in a range of 1 mass % to 80 mass % based on a total mass of 100 mass % of the positive electrode layer.

Solid electrolytes may be used alone or two or more thereof may be used in combination. In addition, when two or more types of solid electrolytes are used, two or more types of solid electrolytes may be mixed.

As the conductive material, known materials can be used, and examples thereof include carbon materials and metal particles. Examples of carbon materials include acetylene black (AB), Ketjenblack (KB), furnace black, VGCF, carbon nanotubes, and carbon nanofibers. Among these, in consideration of electron conductivity, at least one selected from the group consisting of KB, VGCF, carbon nanotubes, and carbon nanofibers may be used. Examples of metal particles include particles of Ni, Cu, Fe, and SUS.

The content of the conductive material in the positive electrode layer is not particularly limited.

Examples of binders include polyamide-based resins, acrylonitrile butadiene rubber (ABR), butadiene rubber (BR), polyvinylidene fluoride (PVdF), polytetrafluoroethylene (PTFE), and styrene butadiene rubber (SBR). The content of the binder in the positive electrode layer is not particularly limited.

The thickness of the positive electrode layer is not particularly limited.

The positive electrode layer can be formed by a conventionally known method.

For example, a positive electrode active material, and as necessary, other components are added to a solvent and stirred to produce a positive electrode layer slurry, and the positive electrode layer slurry is applied onto one surface of a support such as a positive electrode current collector and dried to obtain a positive electrode layer.

Examples of solvents include butyl acetate, butyl butyrate, heptane, and N-methyl-2-pyrrolidone.

The method of applying a positive electrode layer slurry onto one surface of a support such as a positive electrode current collector is not particularly limited, and examples thereof include a doctor blade method, a metal mask printing method, an electrostatic coating method, a dip coating method, a spray coating method, a roll coating method, a gravure coating method, and a screen printing method.

As the support, one having self-supporting properties can be appropriately selected and used, and the support is not particularly limited, and for example, a metal foil such as Cu and Al can be used.

### Positive Electrode Current Collector

As the positive electrode current collector, a known metal that can be used as a current collector for a battery can be used. Examples of such metals include metal materials containing one, two or more elements selected from the group consisting of Cu, Ni, Al, V, Au, Pt, Mg, Fe, Ti, Co, Cr, Zn, Ge, and In. Examples of positive electrode current collectors include SUS, aluminum, nickel, iron, titanium and carbon.

The form of the positive electrode current collector is not particularly limited, and various forms such as a foil form and a mesh form can be used.

### Electrolyte Layer

The electrolyte layer contains an electrolytic solution containing dimethylsulfamoyl fluoride (MeFSA) of Formula (1) as a solvent and lithium bis(fluorosulfonyl)imide (LiFSI) of Formula (2) as an electrolyte salt.

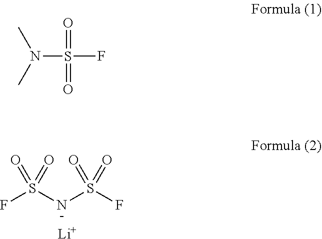

The molar ratio of LiFSI and MeFSA may be LiFSI:MeFSA=1:12 to 1:3.

The electrolyte layer may include a separator for retaining an electrolytic solution and preventing the positive electrode layer and the negative electrode layer from coming into contact with each other and the like. The thickness of the electrolyte layer is not particularly limited, and may be, for example, 0.1 μm or more or 1 μm or more, and 2 mm or less or 1 mm or less.

Examples of separators include those made of resins such as polyethylene (PE), polypropylene (PP), polyester and polyamide. The separator may have a single-layer structure or a multi-layer structure. Examples of separators having a multi-layer structure include a separator having a two-layer structure of PE/PP and a separator having a three-layer structure of PP/PE/PP or PE/PP/PE. The separator may be made of a nonwoven fabric such as a cellulose nonwoven fabric, a resin nonwoven fabric, or a glass fiber nonwoven fabric.

### Negative Electrode

The negative electrode has a negative electrode layer. The negative electrode contains, as necessary, a negative electrode current collector.

### Negative Electrode Layer

The negative electrode layer contains a Si-based active material as a negative electrode active material, and contains, as necessary, the conductive material, the binder and the like.

The Si-based active material may be elemental Si, a Si oxide, a Si—C composite, a Si alloy or the like. The Si-based active material may be a porous Si. The Si-based active material may be a diamond-type crystal Si, a Si clathrate, an amorphous Si or the like and may be a porous Si clathrate. The Si clathrate may be a type I clathrate I or a type II clathrate.

The negative electrode active material may be a negative electrode active material particle.

The average particle size D50 of the negative electrode active material particle may be 0.5 μm or more, 2.6 μm or less, or 0.7 μm or less.

The specific surface area of the negative electrode active material particle may be 1 m²/g or more or 25 m²/g or more and may be 60 m²/g or less or 33 m²/g or less.

The thickness of the negative electrode layer is not particularly limited.

### Negative Electrode Current Collector

Examples of materials of the negative electrode current collector include SUS, copper and nickel. Examples of the form of the negative electrode current collector include a foil form and a plate form. The shape of the negative electrode current collector in a plan view is not particularly limited, and examples thereof include a circular shape, an elliptical shape, a rectangular shape and any polygonal shape. In addition, the thickness of the negative electrode current collector varies depending on the shape, and may be, for example, in a range of 1 μm to 50 μm or in a range of 5 μm to 20 μm.

As necessary, the battery includes an exterior body in which a positive electrode layer, a negative electrode layer, an electrolyte layer and the like are accommodated.

The material of the exterior body is not particularly limited as long as it is stable in an electrolyte, and examples thereof include resins such as polypropylene, polyethylene, and acrylic resins.

Examples of shapes of batteries include a coin shape, a laminate shape, a cylindrical shape, and a rectangular shape.

The battery may be a primary battery or a secondary battery. Applications of batteries include power sources for vehicles, for example, hybrid electric vehicles (HEV), plug-in hybrid electric vehicles (PHEV), battery electric vehicles (BEV), gasoline vehicles, and diesel vehicles. Among these, the battery may be used as a power source for driving hybrid electric vehicles (HEV), plug-in hybrid electric vehicles (PHEV) or battery electric vehicles (BEV). In addition, the battery may be used as a power source for moving objects (for example, trains, ships, and aircrafts) other than vehicles, and may be used as a power source for electrical products such as information processing devices.

### Reference Experiment Examples 1 to 5

### Electrolytic Solution

In Reference Experiment Example 1, a first electrolytic solution containing LiFSI as an electrolyte salt and MeFSA as a solvent (LiFSI:MeFSA=molar ratio 1:12) was used.

In Reference Experiment Example 2, a second electrolytic solution containing LiFSI as an electrolyte salt and MeFSA as a solvent (LiFSI:MeFSA=molar ratio) 1:8 was used.

In Reference Experiment Example 3, a third electrolytic solution containing LiFSI as an electrolyte salt and MeFSA as a solvent (LiFSI:MeFSA=molar ratio 1:4) was used.

In Reference Experiment Example 4, a fourth electrolytic solution containing LiFSI as an electrolyte salt and MeFSA as a solvent (LiFSI:MeFSA=molar ratio 1:3) was used.

In Reference Experiment Example 5, an electrolytic solution containing 1.2 M LiPF₆ as an electrolyte salt and a mixed solvent of ethylene carbonate (EC), dimethyl carbonate (DMC), ethyl methyl carbonate (EMC) and fluoroethylene carbonate (FEC) as a solvent was used as a conventional electrolytic solution.

### Measurement of Li Electrode Potential

Using a three-electrode cell, the Li electrode potential when each electrolytic solution of Reference Experiment Examples 1 to 5 was used was measured by the following method.

A 1 mM ferrocene (Fc) was added to each electrolytic solution of Reference Experiment Examples 1 to 5, and a three-electrode cell using platinum as a working electrode and Li metal as a counter electrode and a reference electrode was prepared.

Cyclic voltammetry (CV) measurement was performed using a three-electrode cell in a potential range of 2.5 V to 4 V vs Li/Li⁺, and the redox average potential of ferrocene on the working electrode was measured with respect to Li.

It was known that the redox potential of ferrocene was almost constant (about 3.2 V vs. Li/Li⁺) regardless of the concentration and type of the electrolytic solution. Therefore, the ferrocene redox potential that varied depending on the type of the electrolytic solution was thought to be due to the electrode potential of Li used as a reference electrode fluctuating depending on the type of the electrolytic solution.

Therefore, the measured “ferrocene redox potential with respect to Li” can be rewritten as “Li electrode potential with respect to ferrocene,” and thus the Li electrode potential with respect to ferrocene is shown in Table 1.

### Calculation of Average Dissolution and Precipitation Efficiency

Using a two-electrode coin cell, the average dissolution and precipitation efficiency of the Li electrode when each electrolytic solution of Reference Experiment Examples 1 to 5 was used was calculated by the following method.

Using each electrolytic solution of Reference Experiment Examples 1 to 5, a two-electrode coin cell using a copper foil as a working electrode, Li metal as a counter electrode, and a glass filter as a separator was prepared.

In a two-electrode coin cell, Li metal was precipitated on a copper foil at a current density of 0.5 mAh/cm² for 1 hour, and the Li metal was then dissolved at the same current density until the voltage reached 0.5 V (cut-off voltage), which constitutes one cycle, and the average dissolution and precipitation efficiency of the Li electrode when this cycle was repeated was calculated.

The average dissolution and precipitation efficiency was calculated after 14 cycles in Reference Experiment Example 1, 19 cycles in Reference Experiment Example 2, and 20 cycles in Reference Experiment Examples 3 to 5. The results are shown in Table 1.

TABLE 1

| | | | Average dissolution |
|---|---|---|---|
| | | Li electrode | and precipitation |
| | MeFSA/LiFSI | potential | efficiency |
| | (molar ratio) | (V vs. Fc/Fc⁺) | (%) |
| Reference | 12 | −2.98 | 96.3 |
| Experiment | | | |
| Example 1 | | | |
| Reference | 8 | −2.92 | 97.3 |
| Experiment | | | |
| Example 2 | | | |
| Reference | 4 | −2.89 | 97.5 |
| Experiment | | | |
| Example 3 | | | |
| Reference | 3 | −2.88 | 98.1 |
| Experiment | | | |
| Example 4 | | | |
| Reference | — | −3.14 | 95.4 |
| Experiment | | | |
| Example 5 | | | |

As shown in Table 1, it can be understood that the Li electrode potential increased and upshifted in Reference Experiment Examples 1 to 4 compared to Reference Experiment Example 5. In addition, it can be understood that, in Reference Experiment Examples 1 to 4, the average dissolution and precipitation efficiency was improved compared to Reference Experiment Example 5, and thus the reactivity of the Li electrode increased when an electrolytic solution containing LiFSI as an electrolyte salt and MeFSA as a solvent was used.

### Examples 1 to 12 and Comparative Examples 1 to 3

### Production of Half-Cell

In each of Examples 1 to 12 and Comparative Examples 1 to 3, a half-cell including the following negative electrode layer, negative electrode current collector, counter electrode, and electrolytic solution was produced.

A negative electrode layer containing a Si-based active material as a negative electrode active material, a polyamide-based resin as a binder, and KB and VGCF as conductive materials at a ratio of 82:12:5:1 (wt %) in that order was prepared. As the polyamide-based resin, one obtained by thermally curing a polyamic acid solution at a high temperature was used.

As the Si-based active materials of Examples 1 to 12 and Comparative Examples 1 to 3, those shown in Table 2 were used.

The first diamond-type crystal Si particles shown in Table 2 had an average particle size D50 of 2.6 μm and a specific surface area of 1 m²/g.

The second diamond-type crystal Si (nano-sized crystal Si) particles shown in Table 2 had an average particle size D50 of 0.5 μm and a specific surface area of 25 m²/g.

The porous clathrate type II Si (pcSi) particles shown in Table 2 had an average particle size D50 of 0.7 μm and a specific surface area of 33 m²/g.

A Cu foil was used as the negative electrode current collector.

Li metal was used as the counter electrode.

In Examples 1 to 3, the first electrolytic solution used in Reference Experiment Example 1 was used.

In Examples 4 to 6, the second electrolytic solution used in Reference Experiment Example 2 was used.

In Examples 7 to 9, the third electrolytic solution used in Reference Experiment Example 3 was used.

In Examples 10 to 12, the fourth electrolytic solution used in Reference Experiment Example 4 was used.

In Comparative Examples 1 to 3, the conventional electrolytic solution used in Reference Experiment Example 5 was used.

### Calculation of Average Coulombic Efficiency for 50 Cycles Using Half-Cell

In each of Examples 1 to 12 and Comparative Examples 1 to 3, the charging capacity was set to 1,200 mAh/g, each half-cell was charged and discharged for 50 cycles under conditions of a temperature of 25° C. and 0.1C, and the average coulombic efficiency of each half-cell was calculated. The results are shown in Table 2.

$$Coulombic efficiency ( \% ) = ( discharging capacity / charging capacity ) \times 100$$

TABLE 2

| | | | Average |
|---|---|---|---|
| | | | coulombic |
| | MeFSA/LiFSI | Si-based active | efficiency |
| | (molar ratio) | material | (%) |
| Example 1 | 12 | First diamond-type | 99.1 |
| | | crystal Si | |
| Example 2 | 12 | Second diamond- | 99.5 |
| | | type crystal Si | |
| Example 3 | 12 | Porous clathrate | 98.9 |
| | | type II Si | |
| Example 4 | 8 | First diamond-type | 99.0 |
| | | crystal Si | |
| Example 5 | 8 | Second diamond- | 99.5 |
| | | type crystal Si | |
| Example 6 | 8 | Porous clathrate | 99.3 |
| | | type II Si | |
| Example 7 | 4 | First diamond-type | 99.3 |
| | | crystal Si | |
| Example 8 | 4 | Second diamond- | 99.5 |
| | | type crystal Si | |
| Example 9 | 4 | Porous clathrate | 99.1 |
| | | type II Si | |
| Example 10 | 3 | First diamond-type | 99.4 |
| | | crystal Si | |
| Example 11 | 3 | Second diamond- | 99.5 |
| | | type crystal Si | |
| Example 12 | 3 | Porous clathrate | 99.4 |
| | | type II Si | |
| Comparative | — | First diamond-type | 98.9 |
| Example 1 | | crystal Si | |
| Comparative | — | Second diamond- | 98.6 |
| Example 2 | | type crystal Si | |
| Comparative | — | Porous clathrate | 98.8 |
| Example 3 | | type II Si | |

As shown in Table 2, it was confirmed that the average coulombic efficiency over 50 cycles was improved by 0.1 to 0.6% in the half-cell compared to the conventional electrolytic solution.

### Examples 13 to 15 and Comparative Examples 4 to 6

### Production of Full-Cell

In each of Examples 13 to 15 and Comparative Examples 4 to 6, a full-cell including the following negative electrode layer, positive electrode layer, and electrolytic solution was produced.

A negative electrode layer containing a Si-based active material as a negative electrode active material, a polyamide-based resin as a binder, and KB and VGCF as conductive materials at a ratio of 82:12:5:1 (wt %) in that order was prepared.

As the Si-based active materials of Examples 13 to 15 and Comparative Examples 4 to 6, those shown in Table 3 were used.

The first diamond-type crystal Si, second diamond-type crystal Si (nano-sized crystal Si), and porous clathrate type II Si (pcSi) shown in Table 3 were the same as those used in the half-cell shown in Table 2.

A positive electrode layer containing NCM811 as a positive electrode active material, PVdF as a binder, and AB as a conductive material at a ratio of 90:5:5 (wt %) in that order was prepared.

As the separator, a three-layer separator having PE/PP/PE micropores was used.

In Examples 13 to 15, the third electrolytic solution (LiFSI:MeFSA=1:4 (molar ratio)) used in Reference Experiment Example 3 was used.

In Comparative Examples 4 to 6, the conventional electrolytic solution used in Reference Experiment Example 5 was used.

The amount of the electrolytic solution injected into the full-cell was 700 μl.

Calculation of Discharging Capacity Retention Rate after 100 Cycles Using Full-Cell

In each of Examples 13 to 15 and Comparative Examples 4 to 6, the charging capacity was set to 1,200 mAh/g, and at a temperature of 25° C. and in a cut-off voltage range of 2.5 V to 4.35 V, each full-cell was charged and discharged for 100 cycles, and the discharging capacity retention rate of each full-cell was calculated. In the 1st, 50th, and 100th cycles, charging and discharging were performed under a condition of 0.1C, and in the 2nd to 49th, and 51st to 99th cycles, charging and discharging were performed under a condition of 1C. The results are shown in Table 3.

TABLE 3

| | | | Discharging |
|---|---|---|---|
| | | | capacity |
| | MeFSA/LiFSI | Si-based active | retention rate |
| | (molar ratio) | material | (%) |
| Example 13 | 4 | First diamond-type | 34.1 |
| | | crystal Si | |
| Example 14 | 4 | Second diamond- | 56.1 |
| | | type crystal Si | |
| Example 15 | 4 | Porous clathrate | 77.7 |
| | | type II Si | |
| Comparative | — | First diamond-type | 55.7 |
| Example 4 | | crystal Si | |
| Comparative | — | Second diamond- | 43.6 |
| Example 5 | | type crystal Si | |
| Comparative | — | Porous clathrate | 39 |
| Example 6 | | type II Si | |

FIG. 2 is a graph showing the initial coulombic efficiency, average coulombic efficiency, and discharging capacity retention rate measured in Examples 7 to 9, and 13 to 15 and Comparative Examples 1 to 6.

As shown in Table 3, it was confirmed that the discharging capacity retention rate after 100 cycles was improved by about 2 times in the full-cell compared to the conventional electrolytic solution.

As shown in FIG. 2, it was confirmed that, in the conventional electrolytic solution, the discharging capacity retention rate decreased when the specific surface area of the Si-based active material increased, but in the electrolytic solution of the present disclosure, the irreversible capacity decreased when the specific surface area of the Si-based active material increased, and the discharging capacity retention rate was improved, and it can be understood that the results showed a tendency opposite to the conventional electrolytic solution.

What is claimed is:

1. A battery having a positive electrode layer, an electrolyte layer and a negative electrode layer in that order,
wherein the electrolyte layer contains dimethylsulfamoyl fluoride (MeFSA) and lithium bis(fluorosulfonyl)imide (LiFSI), and
wherein the negative electrode layer contains a Si-based active material as a negative electrode active material.

2. The battery according to claim 1, wherein the molar ratio of LiFSI and MeFSA is LiFSI:MeFSA=1:12 to 1:3.

3. The battery according to claim 1, wherein the negative electrode active material is a porous Si clathrate.

4. The battery according to claim 1,
wherein the negative electrode active material is a negative electrode active material particle, and
wherein the D50 of the negative electrode active material particle is 0.7 μm or less.

5. The battery according to claim 1,
wherein the negative electrode active material is a negative electrode active material particle, and
wherein the specific surface area of the negative electrode active material particle is 25 to 60 m²/g.
